(19) United States
(12) Patent Application Publication
(10) Pub. No.: US 2024/0354568 A1
(43) Pub. Date: Oct. 24, 2024

(54) METHODS AND SYSTEMS FOR DEEP DISTILLING

(71) Applicant: THE BOARD OF REGENTS OF THE UNIVERSITY OF TEXAS SYSTEM, Austin, TX (US)

(72) Inventors: Milo M. LIN, Dallas, TX (US); Paul J. BLAZEK, Irving, TX (US)

(73) Assignee: THE BOARD OF REGENTS OF THE UNIVERSITY OF TEXAS SYSTEM, Austin, TX (US)

(21) Appl. No.: 18/686,254

(22) PCT Filed: Aug. 19, 2022
(86) PCT No.: PCT/US2022/040885

§ 371 Date: Feb. 23, 2024

Related U.S. Application Data
(60) Provisional application No. 63/239,482, filed on Sep. 1, 2021.

(51) Int. Cl. G06N 3/08

(52) U.S. Cl. CPC G06N 3/08

(57) ABSTRACT

A computer-implemented technique for deep distilling is disclosed. The technique includes obtaining training samples for training an artificial neural network: determining multiple sub concepts within the training samples such that a minimum number of linearly separable sub concept regions are formed: processing the sub concepts to obtain neurons that form an output of the neural network: organizing the neurons into one or more groups with similar connectivity patterns: and interpreting the neurons as implementing logical functions.

### RELATED APPLICATIONS

This application claims benefit of priority under 35 U.S.C. § 119 (c) of U.S. Provisional Application No. 63/239,482, filed Sep. 1, 2021. The disclosure of the prior application is considered part of and is herein incorporated by reference in the disclosure of this application in its entirety. This application is related to PCT Application No. PCT/US2021/019470, which is incorporated herein by reference.

### BACKGROUND

The systematization of reasoning allows ideas to be verified, disseminated, improved, and even automated. This can be true across various scientific disciplines, manifesting in mathematical equations, medical treatment protocols, chemical syntheses, and computer algorithms. The automation of reasoning can be a central goal of artificial intelligence (AI) and machine learning. However, an obstacle can be the trade-off between models that humans can explain (e.g. expert systems, logistic models, decision trees) and models that have high predictive accuracy (e.g. random forests, support vector machines, and neural networks).

Explainability of a machine learning model can make the model more amenable to modification and rational design. It can provide the guarantees necessary for mathematics and the sciences and the predictability needed for high stakes uses, such as medicine or autonomous vehicles. The explainability can be tested based on whether it can be translated to understandable computer code, as this provides an unambiguous explanation and a platform for testing performance. This can be a goal of inductive programming or programming by example, whereby a set of training examples are distilled down to the underlying reasoning that maps inputs to outputs.

Known techniques for inductive programming have been restricted to writing code to automate simple repetitive tasks that receive simple inputs, performs simple manipulative operations, and only contains a few lines of code. This is mainly because of the large space of functions through which they must search to compose functional code, which can be distinct from two other forms of automatic programming. The first form performs automatic code completion and debugging, as implemented by many integrated development environments. The second form receives a user's high-level description of the program to be translated into code, such as by providing a sketch of the program or even a textual description fed through natural language processing (e.g., recent developments with GPT-3).

Known techniques to train deep neural networks use error optimization, for example, gradient descent via backpropagation. Such known techniques produce fundamentally non-interpretable black box networks that are prone to making nonsensical decisions when encountering rare edge cases. The need for human interpretability and the ability to provide guarantees is necessary in applications such as medicine, autonomous driving, and science/mathematics.

### SUMMARY

A computer-implemented method for deep distilling is disclosed. The method can include: obtaining training samples for training an artificial neural network: determining multiple sub concepts within the training samples such that a minimum number of linearly separable sub concept regions are formed: processing the sub concepts to obtain neurons that form an output of the neural network: organizing the neurons into one or more groups with similar connectivity patterns: and interpreting the neurons as implementing logical functions.

In example embodiments, the organizing of the neurons can include arranging the neurons within each group in a vector or a matrix structure such that the neurons are iterated over. The logical functions can be in the form of machine-executable format (e.g., Python). The logical functions can be in the form of human-readable format such as decision trees, Bayesian networks, or plain human language. The neural network can be an essence neural network (ENN).

In example embodiments, the method can include determining connectivity patterns of each neuron by normalizing its incoming weight: determining the logical functions based on weights each neuron applies to its inputs and the respective neuron's bias factor. The processing of the sub concepts to obtain neurons can include: processing the sub concepts to obtain differentia neurons associated with the sub concepts, wherein the differentia neurons provide a relative distinction between the sub concepts: integrating the differentia neurons to obtain sub concepts neurons, wherein the sub concepts neurons provide an absolute distinction of sub concepts: and integrating the sub concepts neurons to obtain concept neurons that form an output of the neural network. In example embodiments, unsupervised learning can be used to determine hierarchical structure of the sub concepts.

A system for deep distilling is disclosed. The system comprises a processor and an associated memory, the processor being configured to: obtain training samples for training an artificial neural network: determine multiple sub concepts within the training samples such that a minimum number of linearly separable sub concept regions are formed: process the sub concepts to obtain neurons that form an output of the neural network: organize the neurons into one or more groups with similar connectivity patterns: and interpret the neurons as implementing logical functions.

### BRIEF DESCRIPTION OF DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 shows a flowchart for deep distilling according to an exemplary embodiment of the present disclosure;

FIG. 2 shows a deep distilling flow to automatically write computer code according to an exemplary embodiment of the present disclosure;

FIG. 3 shows organizing neurons into groups with similar connectivity patterns according to an exemplary embodiment of the present disclosure;

FIG. 4 illustrates interpreting neuron functions according to an exemplary embodiment of the present disclosure;

FIG. 5 shows rule 30 elementary cellular automata according to an exemplary embodiment of the present disclosure;

FIG. 6 shows rule 256 elementary cellular automata according to an exemplary embodiment of the present disclosure;

FIG. 7 illustrates game of life cellular automata according to an exemplary embodiment of the present disclosure;

FIG. 8 shows a comparison between rule 30, rule 110 and game of life cellular automata according to an exemplary embodiment of the present disclosure;

FIG. 9 illustrates a comparison between rule 30 with error and with no error according to an embodiment of the present disclosure:

FIG. 10 illustrates maximum absolute value problem according to an embodiment of the present disclosure;

FIG. 11 shows shape orientations problem according to an embodiment of the present disclosure:

FIG. 12 shows maximum Boolean satisfiability (MAX-SAT) according to an embodiment of the present disclosure: and

FIG. 13 illustrates an example diagram for a system to perform operations according to an embodiment of the present disclosure.

### DESCRIPTION

The present disclosure describes deep distilling for neural networks, which is an inductive programming method that can distill training data down to human-understandable computer code. Deep Distilling can automatically translate databases of training data, such as patient-derived imaging and omics data, into human-understandable code that is predictive of future data inputs. This can be done by performing explainable deep learning to train a neural network, followed by an automated process that condenses an output of a neural network to code. Deep distilling can discover the underlying rules that govern well-defined systems such as cellular automata. Deep distilling can also discover algorithms that tackle non-trivial problems from arithmetic, computer vision, and NP-hard logical problems. The generated code in some cases revealed algorithms that offer better or more robust performance than human-designed algorithms. These results suggest a new framework for approaching algorithmic design and automating the process of learning and discovery.

In example embodiments, deep distilling can be combined with other technologies that process the user's specifications and generate instructive examples that can then be distilled to code. For example, the shape orientation problem described subsequently can use simple instructive examples (i.e., pure horizontal and vertical full-length lines) to generate a robust and generalizable algorithm.

The deep distilling process is described with respect to essence neural networks (ENNs), but it can be applicable for any type of interpretable neural network. ENNs can perform well on various classes of problems, including both computer vision and logical reasoning tasks. For symbolic tasks, ENN weights are sufficiently interpretable to be translated manually into pseudocode. The integration of symbolism can allow ENNs to be explainable and capable of hierarchical organization, deliberation, symbolic manipulation, and concept generalization. They can also be more modular, sparse, and robust to noise and adversarial attacks. These networks can represent a new interpretation of the complex connections and activities of biological neural networks and how they give rise to perception and reasoning.

Furthermore, ENNs can be a more generalized form of other machine learning models. When they are purely symbolic as we have used them here, they can serve as a rule-based system, such as they behaved on cellular automata. The equivalency of neuron functions with AND-OR trees and their structure indicates that they can also be viewed as a more general type of decision tree (or potentially random forests in the case of consensus ENNs) that is not limited to splitting a single feature at a time. Furthermore, because ENNs focus on computing and integrating many hyperplane distinctions, they also generalize approaches like SVMs and logistic regression. This should allow for greater exploration of variations on ENN design, for example by using kernel SVMs to design artificial neurons that make non-hyperplane distinctions.

As described in detail in application no. PCT/US2021/019470, ENN training first divides the training samples into sub concepts, which are subsets of similar training samples with the same target output (i.e., the same target concept). Thereafter, a first hidden layer of neurons (called differentia neurons) is constructed such that each neuron distinguishes a pair of sub concepts and is designed by computing linear support-vector machines (SVMs) between these sub concepts, giving the learned weights and bias factor to that differentia neuron. A second hidden layer of neurons (called sub concept neurons) is constructed such that each neuron represents a specific sub concept and is designed by computing SVMs-using the differentia neuron outputs-between the training samples of that sub concept versus all other training samples. A final output layer of neurons (called concept neurons) is constructed such that each neuron represents a specific concept and is designed by computing SVMs-using the sub concept neuron outputs-between the training samples of that concept versus all other training samples.

The present disclosure provides an ENN training technique for learning sub concepts within the training data so that ENN training automatically learns an appropriate number of sub concepts. In the training technique described in application no. PCT/US2021/019470, the training samples belonging to each concept were divided into sub concepts using hierarchical clustering, finding a fixed value to cut each hierarchical tree such that the total number of cut clusters across all concepts was equal to a user-defined number of clusters (i.e., sub concepts). Before implementing either method, for those tasks for which the inputs were discretely symbolic, with a I indicating the presence of a feature and 0 representing its absence, the present disclosure describes dividing the concepts into new concepts such that each training sample shares at least one feature with another training sample. This is done so that each concept had a shared familial resemblance. By representing each concept as a graph, each sample as a node and the presence of an edge representing shared features, depth-first search finds isolated graphs (i.e., components) that ultimately form the new concepts.

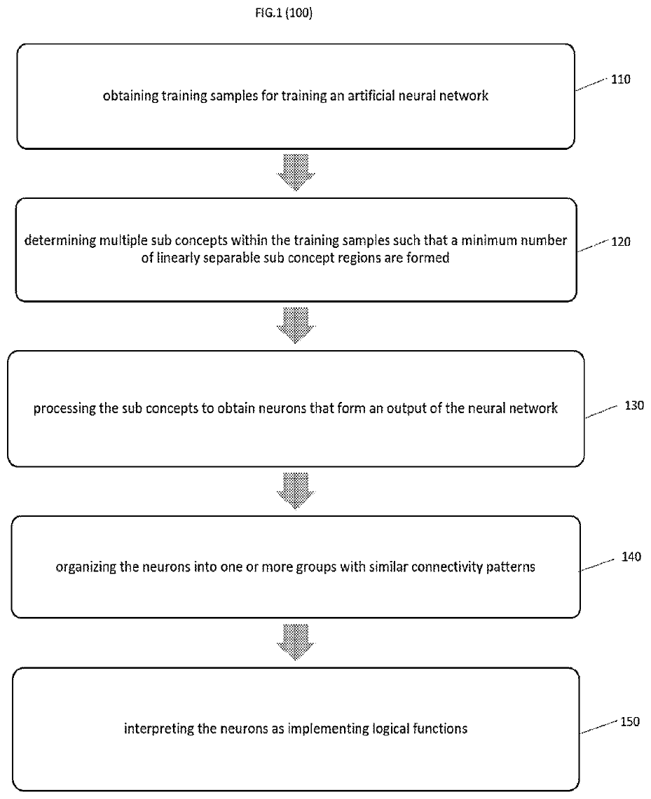

FIG. 1 illustrates a flowchart for a method 100 for deep distilling a neural network. The method 100 can include a step 110 of obtaining training samples (dataset) for training the neural network. In an example embodiment, a rectangles dataset can be synthetically generated, with each image being a 28×28 black image with a white rectangular oriented horizontally or vertically. The convex dataset can also be synthetically generated, each image containing a filled convex or non-convex shape. For both the rectangle and convex data sets there can be about 50,000 training images and 10,000 test images. The Modified National Institute of Standards and Technology (MNIST) dataset can be used that includes 70,000 28×28 grayscale images of handwritten digits 0 through 9.

In an example embodiment, training images used can be 28×28 black images with a one-pixel-wide stripe across the full length or height of the image, which means there can be 56 total training images. The diagonal line and box outline datasets can be generated as follows. For each pair of possible heights and widths of non-square rectangles in the image, no more than 50 unique rectangles with randomly placed corners can be generated. This rectangle's outline can be drawn to make the box outline datasets, and one of its two diagonals can be chosen randomly to make the diagonal line dataset. Further details of an example training set are described in PCT application no. PCT/US2021/019470, which is incorporated by reference.

The method 100 can include a step 120 of determining multiple sub concepts within the training samples such that a minimum number of linearly separable sub concept regions are formed. The sub concepts can have the same target output (i.e. the same target concept). A hierarchical linkage clustering can be used within each class, choosing a single cutoff value for all concepts' linkage trees such that the desired total number of sub concepts be obtained. Ward clustering metric can provide good results due to its emphasis on generating compact clusters of comparable size. Further details of determining the multiple sub concepts are described in PCT application no. PCT/US2021/019470.

In an example embodiment, for dividing the concepts into sub concepts, hierarchical clustering can be performed on the training samples from each concept separately, and all the hierarchical trees can be cut at a cutoff value that results in a predefined minimum number of sub concepts. Linear support vector machines (SVMs) can be computed for every pair of sub concept to find hyperplanes that separate the sub concepts training samples. This hyperplane can divide up input space into two half-spaces, w·x⁽⁻⁾+b<0 and w·x⁽⁺⁾+b>0, with all the negative half-space points x(−) satisfying the first inequality and the positive half-space points x(+) satisfying the second inequality. If the SVM hyperplane did not perfectly separate the two sub concept's training samples into separate half-spaces, then the sub concepts were not linearly separable (or at least not easily separable enough). If any of the pairs of sub concepts are not linearly separable, then the desired number of sub concepts can be increased, and the hierarchical trees can be re-cut at a new value to yield an additional sub concept. This process can be repeated until all sub concepts are linearly separated from one another.

In another example embodiment, for dividing the concepts into sub concepts, the concepts for linear separability can be checked in the same manner as described immediately above. Additionally, the misclassification error of each SVM can also computed and stored. For the pair of sub concepts with the greatest misclassification error, the misclassified training samples from one sub concept can be removed and placed into a new sub concept. This process can be repeated until all of the sub concepts are linearly separated from one another.

The method 100 can include a step 130 of processing the sub concepts to obtain neurons that form an output of the neural network. In an example embodiment, the sub concepts can be processed to obtain differentia neurons associated with the sub concepts. The differentia neurons can provide a relative distinction between the sub concepts. The differentia neurons can be integrated to obtain sub concepts neurons, which can provide an absolute distinction of the sub concepts. The sub concepts neurons can be integrated to obtain concept neurons that form an output of the neural network. Further details of processing the sub concepts to obtain neurons are described in PCT application no. PCT/US2021/019470.

In an example embodiment, ternary neurons can be translated to binary neurons. Neurons, as described in the present disclosure can use the sign function as an activation function. The output of neuron n can be y⁽ⁿ⁾=sgn(w⁽ⁿ⁾·x⁽ⁿ⁾+b⁽ⁿ⁾). This is important because the ternary output allows ties to be explicit, such as when an input lies exactly on the hyperplane of a differentia neuron. Because wsgn(x)=w [symbol] _{x>0}−w [symbol] _{-x>0}, it can be mathematically equivalent to substitute a pair of binary neurons for the ternary neuron. One of these neurons can maintain all of the original parameters (i.e., neuron bias and weights of both incoming and outgoing synapses), while the other neuron can take the negative of all these parameters. This may turn the network into a purely Boolean system, though by performing redundant computation.

The method 100 can include a step 140 of organizing the neurons outputted by the neural network into one or more groups with similar connectivity patterns. This can involve separating the neurons into separate groups and then arranging them within the group in a structure (e.g., a vector or matrix) such that the neurons can be iterated over. The input neurons can be pre-arranged by a user, for example as a vector or in a grid (e.g., images). To arrange neurons into groups, the connectivity pattern of each neuron can be determined, and then neurons can be placed into groups with related connectivity.

In an example embodiment, to determine the connectivity pattern for each neuron, its incoming weights can be normalized, dividing by the absolute value of the lowest magnitude non-zero weight. If any of these normalized weights wₙₒᵣₘ are not close to an integer value (i.e. |wₙₒᵣₘ−round(wₙₒᵣₘ)|>ε for some ε>0), then a number α>1 is found such that when all of the weights were multiplied by α they satisfy |αwₙₒᵣₘ—round(αwₙₒᵣₘ)|<ε. The finalized weights of the neuron are w=round(αwₙₒᵣₘ).

For each neuron, the unique non-zero values of w are represented in a vector u, and the neuron's connectivity patterns are examined. For each element uₖ of u, some subset of the incoming connections can be weighted by uₖ. The connectivity pattern of these synapses can be denoted by cₖ=(x: P, g, d), where P represents a particular class of connectivity patterns, g represents the indices of the neuron groups to which P is applied, and d represents the indices that define which exact pattern p∈P applies for uₖ.

Examples of classes of connectivity patterns can include: a column in a matrix, a row in a matrix, multiple columns or rows in a matrix, all elements in a vector, a single element in a matrix, etc. The indices d can specify an exact connectivity pattern in one of these classes, for example indicating the exact row d=(i) from a matrix or the exact indices (i, j) of the element in a matrix.

Neurons can then be placed into the same group if they have the same u, and for each value uₖ they can have the same connectivity pattern class P and incoming group g. The exact indices d may be different for each neuron in the group, in which case the group can still be represented by a single connectivity function, with the various indices d for each neuron making the group iterable. That is, the various neurons in the group can iteratively be handled by using a loop structure to move through all neurons in the group, handling each neuron according to the exact indices that define its exact connectivity pattern. This is how for-loops can be condensed from groups of neurons in the ENN. In an example embodiment, groups of groups can be created in which each group has similar connectivity patterns to other groups, but with, for example, different g or only some of the same (uₖ, cₖ) pairs.

The method 100 can include a step 150 of interpreting the organized neurons as implementing a logical function. This can involve, for each group, determining a single function based on the weights w each neuron applies to its inputs x and by the neuron's bias factor b. The numerical function implemented by the neuron is sign (w·x+b), and this can be converted into a logical function, which can be in machine-executable formats such as Python, as well as human executable formats such as decision trees or Bayesian networks.

In example embodiments, the connectivity patterns mentioned previously can be used to define effective variables. For example, when the same weight is applied to synapses coming from neurons in the same row of a matrix, the sum of the neuron outputs from this row can effectively serve as a single variable, which can be defined and then substituted into the function, reducing the number of terms in the function.

The steps 140 and 150 can be performed by a meta-program that receives as input a trained neural network (e.g. ENN) and writes computer code that performs the step-by-step reasoning process. The computer code can be written in any desired programming language (e.g., Python) or algorithmic instruction format such as a decision tree. The meta-program can be broken down into two modules a organizing module for performing the organizing of step 140 and an interpreting module for performing the interpreting of step 150.

In an example embodiment, an ENN, like other layered neural networks, can be trained on samples of a fixed input size. However, varying the size of the input always can give the same size output code. This can be because either the code may learn to ignore additional variables (such as with cellular automata) or the only difference can be the range over which for-loops are iterated. This may manifest as the same overall code differing only in the value of certain numbers. The code can be distilled multiple times for each problem from data of varying input sizes and it can be observed how these numbers changed as a function of input size. In each case the observed numbers may follow a linear relationship, and to allow manual substitution of these numbers with a linear function of the input size.

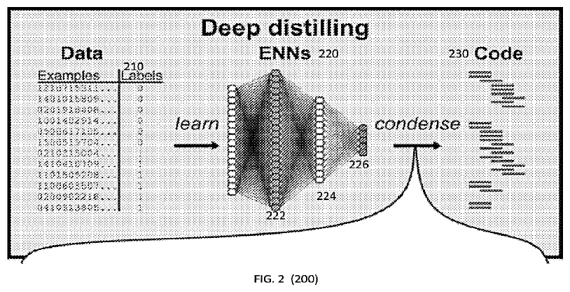

FIG. 2 shows an example flow 200 of a deep distilling process that can automatically write computer code as described in method 100. Training data 210 can be in the form of labeled data. An output of the neural network (e.g., ENN) can be produced based on the training data 210, as previously described in steps 110-130. The neural network 220 can be inspired by a neurocognitive model in which neurons can make relative distinctions (e.g., differentia neurons, 222) or absolute distinctions (e.g. sub concept neurons 224 and concept neurons 226). The output of the neural network 220 can then be condensed into computer code 230, as previously described in steps 140 and 150.

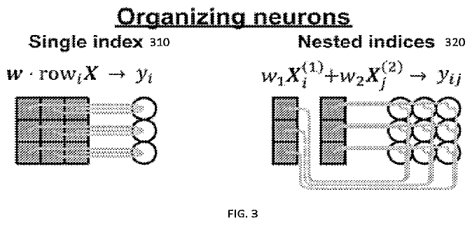

FIG. 3 shows two examples (single index and nested indices) of the organizing neurons into groups with similar connectivity patterns so they can be iterated over by a for-loop, as previously described in step 140. The connectivity pattern of each neuron i in the single index example 310 would be (matrix-row, 1, i), since all the weights come from row i of the 1st neuron group. The neurons in the nested indices example 320 have two unique weights, and for each neuron (i, j) the connectivity patterns are (vector-element, 1, j) and (vector-element, 2, i) for the two elements of u=(w₁, w₂), respectively.

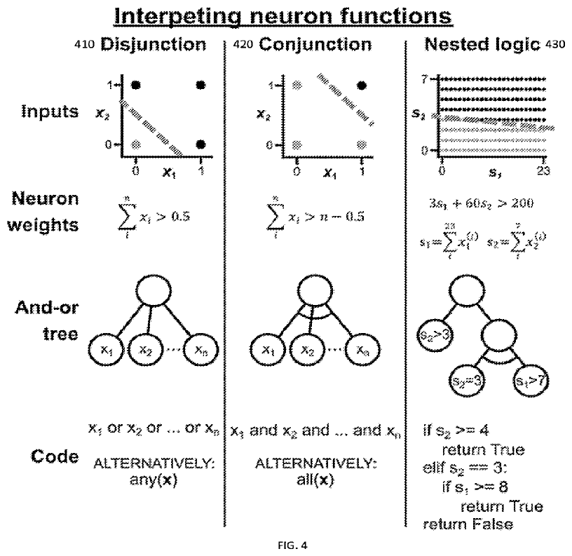

FIG. 4 shows examples of interpreting the organized neurons as implemented a logical function, as previously described in step 150. In each case (disjunction 410, conjunction 420, or nest logic 430), the neuron's weights can define a hyperplane (dashed line) that distinguishes possible discrete inputs xᵢ. This distinction can be understood as and-or trees or as computer code.

In an example embodiment, there are multiple different types of functions the neuron can implement, each of which must be checked. First, a simple check can be used used to determine if the neuron is computing a simple disjunction or conjunction (or their negated alternatives) as illustrated in FIG. 4. When there are no effective variables and all the upstream neurons are Boolean variables (instead of trinary logic variables), then a logical function can be found by enumerating all possible combinations of input values and computing the neuron's output, thus creating a truth table. This truth table is then compressed into its associated Boolean formula.

The nested logic shown in FIG. 4 is possible when effective variables are found. This is because the effective variable has a larger range of discrete values it can take. When there are two variables or effective variables that are weighted differently, a grid can be computed with all possible combinations of values for both variables. In a case where the two weights are different, the output may depend solely on one variable for many possible values it assumes. This means that an entire row or column in the grid has the same output value, such as in FIG. 4, where s2<3 implies the output is always FALSE and it is always TRUE when s2>3. These can be written in the computer code as specific cases that only require the one variable. The remaining rows or columns can be written separately as a function of the other variable, which will be a simple inequality. By doing this, the logic of these more complicated neurons becomes more understandable, as can be seen in FIG. 4 and in the distilled code for the orientation problem.

Distilling Rules from Cellular Automata

To test whether deep distilling can discover the underlying rules that govern a system's observed emergent behavior, it can be applied to cellular automata, which have well-defined rules for the time-evolution of a grid of discrete cells. Because cellular automata have long been used to study emergent behavior with wide-ranging applications across physical, life, and computer sciences, it can be used to test how deep distilling works.

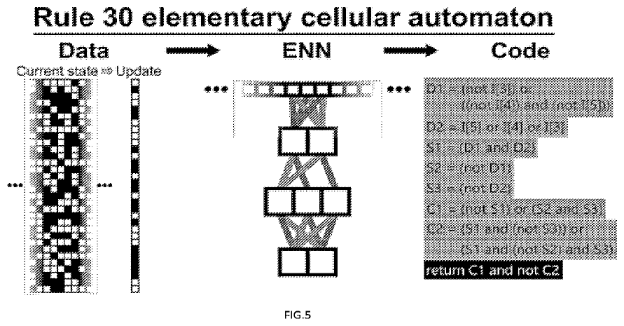

FIG. 5 shows results for single-rule elementary cellular automata according to an example embodiment. The code can be distilled for each of the 256 elementary cellular automata by generating large random grids and labeling each according to the state of the center cell at the next time step (e.g., the chaotic rule 30 shown in FIG. 5). In each case the code correctly ignores all cells outside 35 the central 3-cell neighborhood and reproduces the rule of each automaton via a simple series of progressive logical statements.

In an example embodiment, grids used for training of single-rule elementary cellular automata can be generated randomly, and the output label can be the state of the grid's center cell at the next time step, according to this particular rule of the automaton. Deep distilling could distill this code for a single rule with only a small fraction of the total possible grids, while other methods often require all possible grids to properly learn the rules

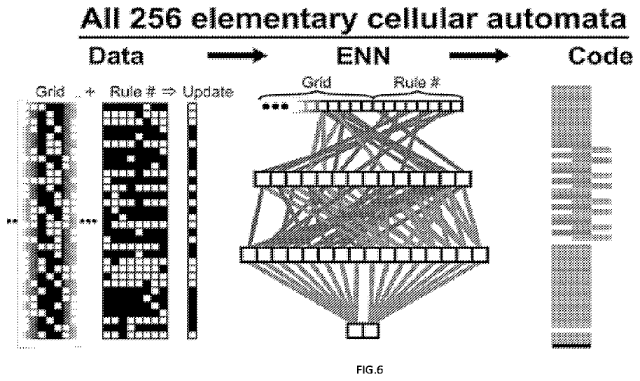

FIG. 6 shows results for all 256 elementary cellular automata simultaneously according to an example embodiment. The code for all 256 elementary cellular automata can be distilled at once by including in the data an 8-bit 38 string to encode the appropriate rule number. As with the one-rule case, the code appropriately ignores non-neighborhood cells but, as expected, is longer and a more complex (schematic in FIG. 2b: full code in Supplementary Text). Interestingly, the code shows that it was able to find an intuitive 41 algorithm, using the rule string to compare the grid's central neighborhood to a rule-specific truth table that 42 determines the correct next state.

In an example embodiment, grids for 256 elementary cellular automata can be generated as for the single-rule case (shown in FIG. 5), but to this an 8-bit string encoding the relevant rule number can be concatenated. For grid sizes of n cells, all 2n possible grids can be generated for each rule. The distilled code can be the same whether trained on samples from all 256 rules or 16 specific rules. These 16 rules can be 1, 2, 4, 8, 16, 64, 127, 128, 191, 223, 239, 247, 251, 253, and 254. These rules can all have 8-bit encodings that contain either a single I bit or a single 0 bit.

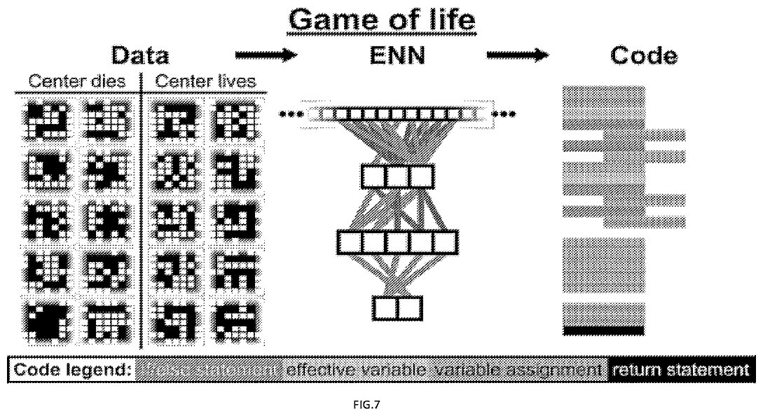

FIG. 7 shows example results for Game of Life cellular automata according to an example embodiment. Game of Life is the most famous cellular automaton due to its interesting emergent properties and Turing completeness. Two-dimensional grids for training can be generated randomly from the Game of Life, and the output label was the state of the grid's center cell at the next time step. It was found that the distilled code can perfectly recapitulate its rules. Particularly, the distilled code can appropriately create an effective variable that represents the total number of live cells in the central cell's neighborhood, as is also done in the rules of the Game of Life.

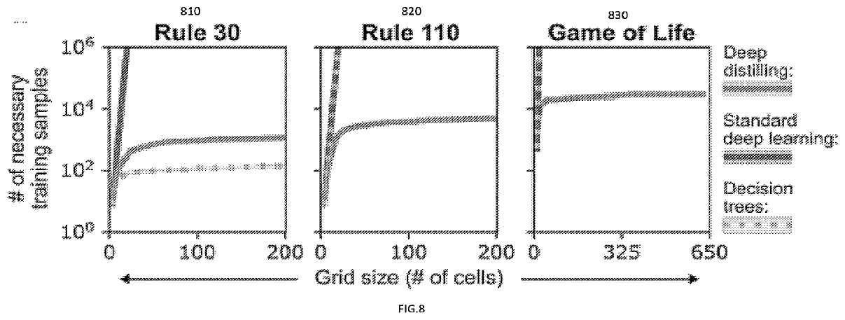

FIG. 8 shows example graphs between the number of necessary training samples and the grid size (number of cells) comparison between rule 30 (shown by 810), rule 110 (shown by 820) and Game of Life cellular automata (shown by 830). While other results for various cellular automata can be similarly generated, the present disclosure shows results for rule 30 because it famously produces chaotic patterns and for rule 110 because it is the simplest known Turing machine and because the decision tree is unable to learn it without training on all 2ⁿ possible n-cell grids.

For the rule 30, rule 110, and game of life automata, the number of training samples necessary for deep distilling to consistently learn the rule can be determined by randomly generating training sets with different numbers of samples and seeing how many samples were necessary to achieve perfect accuracy 10 out of 10 times. This accuracy can be measured by testing on either all 2ⁿ possible n-cell grids or on 1 million of them, whichever was less. The range is shown in FIG. 8 for 5 independent trials of this for each method. For the game of life, it is infeasible to test the standard deep learning and decision trees on 5×5 grids (225≈3.4×106 training samples), so instead it can be trained and tested on 3×3 grids with additional cells added to the perimeter so that grid sizes between 9 (3×3) and 25 (5×5) can be tested.

While these cellular automata may have relatively simple underlying rules, they may turn out to be non-trivial problems for other machine learning systems. For example, as shown in FIG. 8, standard deep neural networks had difficulty learning the rule of both elementary and Game of Life cellular automata as the grids in the training set became larger. They required essentially all 2ⁿ possible n-cell grids to reproducibly guarantee no error, which quickly became impossible to train on as the grid sizes increased.

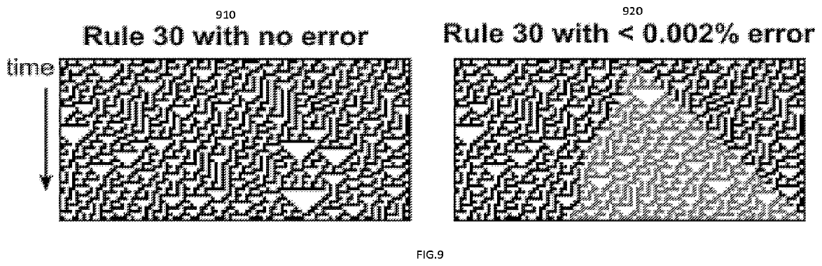

In an example embodiment, without certain performance guarantees, mistakes can enter automata simulations that propagate over time, destroying the accuracy of the results in a hard-to-detect way as shown in FIG. 9—illustrating that when a single error occurs in cellular automata, the error can spread over time (shown in 920) in a subtle way. A simpler, explainable model such as decision trees can learn some of the elementary cellular automata, such as rule 30. However, for 102 of the 256 possible rules, decision tree learning may fail because of ambiguity in choosing which feature to split at different points in the tree, leading to excessively large decision trees and the need for all 2ⁿ sample grids to guarantee perfect performance (e.g., the Turing complete rule 110 in FIG. 8). Not only can the decision trees suffer from this problem again when training on the Game of Life, they may not be able to discover the effective variable found by deep distilling, instead building massive trees that must explicitly check all possible combinations of grids.

The ability of deep distilling to build algorithms with logical functions and effective variables allows them to generalize both well and predictably. The Rule 30 algorithm (FIG. 5), for example, is of a logical form and can therefore produce predictable results with certain guarantees on behavior (for example, there are no rare undesired predictions that black box models can generate, e.g., FIG. 9). Moreover, ENNs can generalize out-of-distribution from the training cases. This ability was found when code was generated for the 256-rule case based on training on only of the automata rules (FIG. 6). The ability to generalize can be easier when distilling succinct, symbolic algorithms than when training larger or less explainable models.

### Deep Distilling Can Discover Complex Generalizable Algorithms

To test whether deep distilling can learn rules that required the entire input space in a less trivial way, it can be used to develop code that receives a list of numbers and returns the index of the number with the largest absolute value (i.e., it computes f(X)=argmax_{x∈X}|x| for the set of real numbers X). In an example embodiment, this can be done by using simple training samples that only contain a single non-zero number.

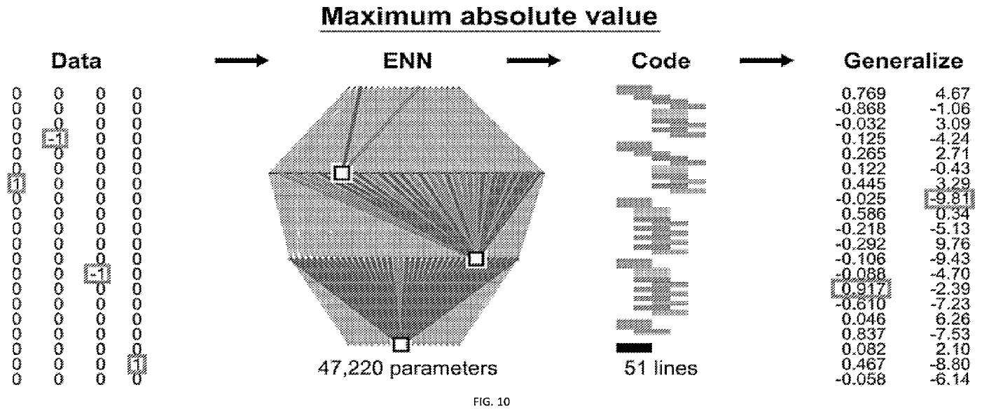

FIG. 10 shows an example process of finding the maximum absolute value in an array by deep distilling, trained a large ENN and condensed it down to more succinct code. The training data can include 20 values, all of which can be zero except for a single number, which could be either 1 or −1, for a total of 40 training samples. It can also be done with 18 and 19 values to generalize the code for input size. To test empirically how well the distilled code is generalized, the code can be verified to work with sets of random numbers between in the ranges [−1, 1], [−10, 10] and [−100, 100].

In an example embodiment, use of for-loops can allow the condensed code to be much smaller in size than the ENN. The argmax function can be computed by iterating once through the numbers and using a mutable variable to hold a largest number, but because the basic ENN structure has not recurrent connections, the condensed code's variables can be effectively immutable. Instead, the distilled code can find the maximum absolute value by making all possible comparisons between numbers and then finding which number is the greatest in every comparison.

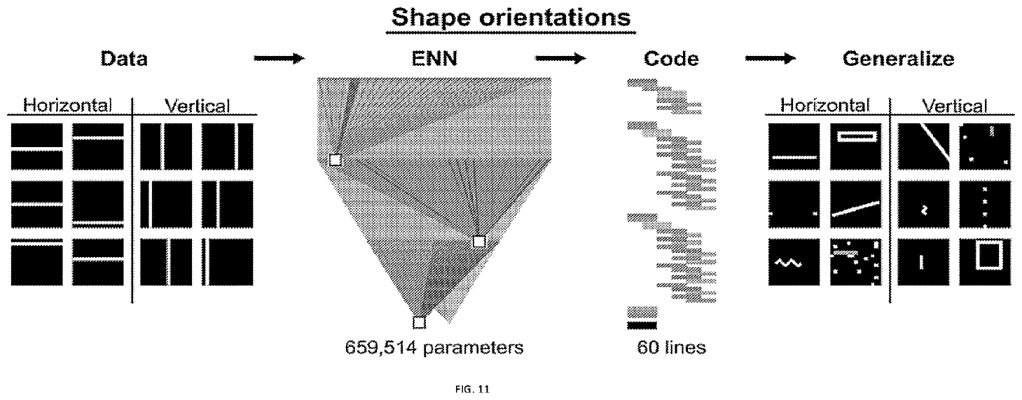

FIG. 11 shows an example process of classifying a shape as cither horizontally or vertically oriented by code that was distilled from images containing full-length white stripes. The code can generalize out-of-distribution to many other types of images. The algorithm found by deep distilling can compare the total brightness of each row to each column, and then determine which rows and columns are present above the background. In an example embodiment, this can be done via several nested levels of logic statements that perform an intricate tie-breaking procedure to resolve some close cases. This algorithm offered certain benefits over standard human-designed approaches such as convolutional filters or the Hough transform. For example, convolutional filters fail to properly classify the orientation of lines made of sparse dots, and the Hough transform performs poorly when there is a low signal-to-noise ratio, while the distilled code is much more robust.

In an example embodiment, the training data can include 28×28 pixel images that contain a black background and a single white stripe that filled an entire row (“horizontal” label) or column (“vertical” label) of the image, for a total of 56 training samples. It can also be done on 27×27 and 26×26 images to generalize the code for input size. Several data sets can be used to assess the generalizability of the code to new problems. These include shorter line segments: diagonally oriented line segments; line segments made of sparse dots; zigzag lines made up of line segments at 45-degree angles; and rectangular boxes. In each case the test images' labels were assigned “horizontal” if the shape was wider than it was tall and “vertical” if it was taller than it was wide.

Images with low a signal-to-noise ratio (SNR) can also be generated in which a line segment can be different shades of gray such that the sum of all its pixel values is equal to a preset total signal intensity level. Then speckle noise can be added to the image, randomly flipping a given number of pixel values. The SNR can be defined as the total intensity of the line divided by the average intensity of the noise in each row, that is:

$$SNR = \frac{total signal}{( num flipped pixels ) / \sqrt{total num pixels}} .$$

Hough transform's ability to distinguish horizontal and vertical shapes can be used as a point of comparison. Hough transform can compute the sum of pixels along lines oriented at different angles and at different angles from the origin. To distinguish between vertical and horizontal shapes, only 0 and 90 degrees are needed. Whichever of these two angles contains the maximum value in the Hough transform can be the output used to classify the image.

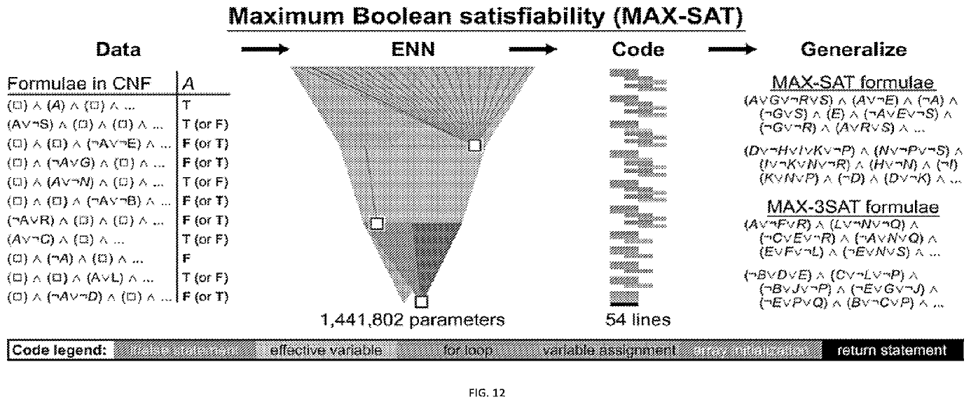

FIG. 12 shows an example process for Maximum Boolean Satisfiability (MAX-SAT) distilled from Boolean formulae in conjunctive normal form (CNF) for which only a single clause was non-empty, containing two variables. The condensed code can be generalized to arbitrary MAX-SAT and MAX-3SAT formulae.

In an example embodiment, deep distilling can produce code that is similar to a human-designed greedy algorithm with the best-known approximation ratio of ¾, with both factoring into their decisions how many clauses will be satisfied and how many will be unsatisfiable when assigning either TRUE or FALSE to variable A. The distilled algorithm outperforms the ¾-approximation algorithm on random MAX-3SAT and MAX-SAT Boolean formulae and outperforms a purer human-designed greedy algorithm (i.e., assign TRUE or FALSE based on which satisfies the most clauses).

For each case described above, the input size can be fixed (e.g. fixed image size) for the ENN training and condensing, so the distilled code can make use of hard-coded numbers (e.g. the number of times to iterate through a for-loop). However, deep distilling can be performed multiple times for various input sizes, each producing the same code but with different hard-coded numbers. These numbers can therefore be replaced by a function of the input size, allowing the code to generalize for any input size, including inputs that are orders of magnitude larger than the training data that would otherwise be much prohibitively large.

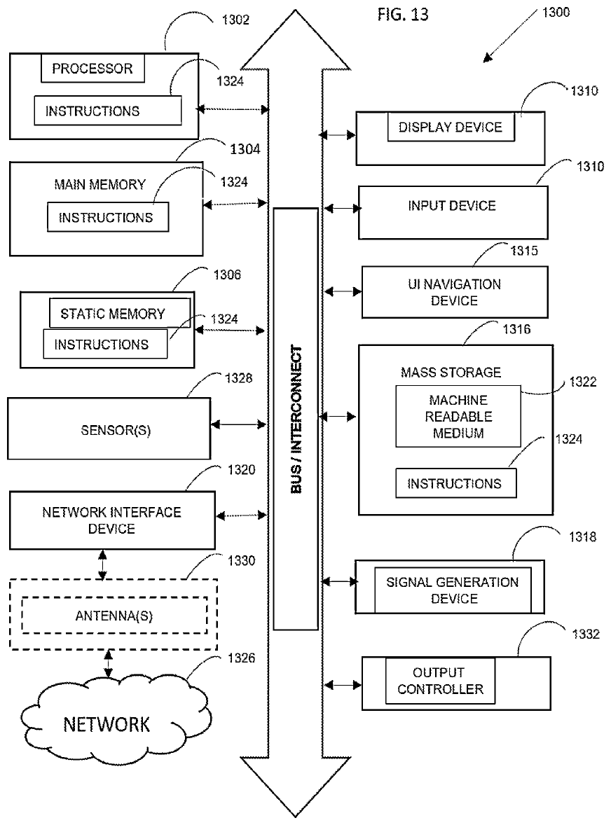

FIG. 13 shows an example system 1300 for deep distilling. The system 1300 can includes a processor 1302 (e.g., a central processing unit (CPU), a graphics processing unit (GPU) or both) and an associated memory 1304. The processor 1302 can be configured to perform all the previously described steps with respect to method 100. In various embodiments, the computer system 1300 can operate as a standalone device or may be connected (e.g., networked) to other machines. In a networked deployment, the machine may operate in the capacity of either a server or a client machine in server-client network environments, or it may act as a peer machine in peer-to-peer (or distributed) network environments.

Example computer system 1300 may further include a static memory 1306, which communicate via an interconnect 1308 (e.g., a link, a bus, etc.). The computer system 1300 may further include a video display unit 1310, an input device 1312 (e.g. keyboard) and a user interface (UI) navigation device 1314 (e.g., a mouse). In one embodiment, the video display unit 1310, input device 1312 and UI navigation device 1314 are a touch screen display. The computer system 1300 may additionally include a storage device 1316 (e.g., a drive unit), a signal generation device 1318 (e.g., a speaker), an output controller 1332, and a network interface device 1320 (which may include or operably communicate with one or more antennas 1330, transceivers, or other wireless communications hardware), and one or more sensors 1328.

The storage device 1316 includes a machine-readable medium 1322 on which is stored one or more sets of data structures and instructions 1324 (e.g., software) embodying or utilized by any one or more of the methodologies or functions described herein. The instructions 1324 may also reside, completely or at least partially, within the main memory 1304, static memory 1306, and/or within the processor 1302 during execution thereof by the computer system 1300, with the main memory 1304, static memory 1306, and the processor 1302 constituting machine-readable media.

While the machine-readable medium 1322 is illustrated in an example embodiment to be a single medium, the term “machine-readable medium” may include a single medium or multiple medium (e.g., a centralized or distributed database, and/or associated caches and servers) that store the one or more instructions 1324.

The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions.

The term “machine-readable medium” shall accordingly be taken to include, but not be limited to, solid-state memories, optical media, and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices: magnetic disks such as internal hard disks and removable disks: magneto-optical disks: and CD-ROM and DVD-ROM disks.

The instructions 1324 may further be transmitted or received over a communications network 1326 using a transmission medium via the network interface device 1320 utilizing any one of several well-known transfer protocols (e.g., HTTP). Examples of communication networks include a local area network (LAN), wide area network (WAN), the Internet, mobile telephone networks, Plain Old Telephone (POTS) networks, and wireless data networks (e.g., Wi-Fi, 3G, and 4G LTE/LTE-A or WiMAX networks).

The term “transmission medium” shall be taken to include any intangible medium that can store, encoding, or carrying instructions for execution by the machine, and includes digital or analog communications signals or other intangible medium to facilitate communication of such software.

Other applicable network configurations may be included within the scope of the presently described communication networks. Although examples were provided with reference to a local area wireless network configuration and a wide area Internet network connection, it will be understood that communications may also be facilitated using any number of personal area networks, LANs, and WANs, using any combination of wired or wireless transmission mediums.

The embodiments described above may be implemented in one or a combination of hardware, firmware, and software. For example, the features in the system architecture 1300 of the processing system may be client-operated software or be embodied on a server running an operating system with software running thereon.

While some embodiments described herein illustrate only a single machine or device, the terms “system”, “machine”, or “device” shall also be taken to include any collection of machines or devices that individually or jointly execute a set (or multiple sets) of instructions to perform any one or more of the methodologies discussed herein.

Examples, as described herein, may include, or may operate on, logic or several components, modules, features, or mechanisms. Such items are tangible entities (e.g., hardware) capable of performing specified operations and may be configured or arranged in a certain manner. In an example, circuits may be arranged (e.g., internally or with respect to external entities such as other circuits) in a specified manner as a module, component, or feature. In an example, the whole or part of one or more computer systems (e.g., a standalone, client or server computer system) or one or more hardware processors may be configured by firmware or software (e.g., instructions, an application portion, or an application) as an item that operates to perform specified operations. In an example, the software may reside on a machine readable medium. In an example, the software, when executed by underlying hardware, causes the hardware to perform the specified operations.

Accordingly, such modules, components, and features are understood to encompass a tangible entity, be that an entity that is physically constructed, specifically configured (e.g., hardwired), or temporarily (e.g., transitorily) configured (e.g., programmed) to operate in a specified manner or to perform part or all operations described herein. Considering examples in which modules, components, and features are temporarily configured, each of the items need not be instantiated at any one moment in time. For example, where the modules, components, and features comprise a general-purpose hardware processor configured using software, the general-purpose hardware processor may be configured as respective different items at different times. Software may accordingly configure a hardware processor, for example, to constitute a particular item at one instance of time and to constitute a different item at a different instance of time.

Additional examples of the presently described method, system, and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

The following references are incorporated in their entirety by reference.

### REFERENCES

1. Arrieta, A. B. et al. Explainable Artificial Intelligence (XAI): Concepts, Taxonomies, Opportunities and Challenges toward Responsible AI 2019. arXiv: 1910.10045 [cs.AI].
2. Gunning, D. & Aha, D. DARPA's Explainable Artificial Intelligence (XAI) Program. AI Magazine 40, 44-58 (June 2019).
3. Hacker, P., Krestel, R., Grundmann, S. & Naumann, F. Explainable AI under contract and tort law: legal incentives and technical challenges. Artificial Intelligence and Law 28 (December 2020).
4. Gulwani, S. et al. Inductive Programming Meets the Real World. Commun. ACM 58, 90-99. ISSN: 0001-0782 (October 2015).
5. Raedt, L. D., Evans, R., Muggleton, S. H. & Schmid, U. Approaches and Applications of Inductive Programming (Dagstuhl Seminar 19202). Dagstuhl Reports 9 (eds Raedt, L. D., Evans, R., Muggleton, S. H. & Schmid, U.) 58-88. ISSN: 2192-5283 (2019).
6. Kitzelmann, E. Inductive Programming: A Survey of Program Synthesis Techniques in Approaches and Applications of Inductive Programming (eds Schmid, U., Kitzelmann, E. & Plasmeijer, R.) (Springer Berlin Heidelberg, Berlin. Heidelberg, 2010), 50-73.
7. Balog, M., Gaunt, A. L., Brockschmidt, M., Nowozin, S. & Tarlow, D. DeepCoder: Learning to Write Programs in 5th International Conference on Learning Representations, ICLR 2017, Toulon, France, Apr. 24-26, 2017, Conference Track Proceedings (OpenReview.net, 2017).
8. Polozov, O. & Gulwani, S. FlashMeta: A Framework for Inductive Program Synthesis in Proceedings of the 2015 ACM SIGPLAN International Conference on Object-Oriented Programming, Systems, Languages, and Applications (Association for Computing Machinery, Pittsburgh, PA, USA, 2015), 107-126. ISBN: 9781450336895.
9. Gulwani, S., Polozov, A. & Singh, R. Program Synthesis 1-119 (NOW, August 2017).
10. Loaiza, F. L., Wheeler, D. A. & Birdwell, J. D. A Partial Survey on AI Technologies Applicable to Automated Source Code Generation tech. rep. (2019).
11. Solar-Lezama, A. The Sketching Approach to Program Synthesis in Programming Languages and Systems (ed Hu, Z.) (Springer Berlin Heidelberg, Berlin, Heidelberg, 2009), 4-13.
12. Brown, T. B. et al. Language Models are Few-Shot Learners 2020. arXiv: 2005.14165 [cs.CL].
13. McCulloch, W. & Pitts, W. A logical calculus of the ideas immanent in nervous activity. The bulletin of mathematical biophysics 5, 115-133 (1943).
14. Wolfram, S. Statistical mechanics of cellular automata. Reviews of Modern Physics 55, 601-644 (July 1983).
15. Gardner, M. Mathematical Games: the fantastic combinations of John Conway's new solitaire game life. Scientific American 223, 120-123 (1970).
16. Rendell, P. A Universal Turing Machine in Conway's Game of Life in 2011 International Conference on High Performance Computing Simulation (2011), 764-772.
17. Puri, R. et al. Project CodeNet: A Large-Scale AI for Code Dataset for Learning a Diversity of Coding Tasks 2021. arXiv: 2105.12655 [cs.SE].

1. A computer-implemented method for deep distilling, the method comprising:
obtaining one or more training samples for training an artificial neural network;
determining multiple sub concepts within the training samples such that a minimum number of linearly separable sub concept regions are formed;
processing the sub concepts to obtain neurons that form an output of the neural network;
organizing the neurons into one or more groups with similar connectivity patterns; and
interpreting the neurons as implementing one or more logical functions.

2. The method of claim 1, wherein the logical functions are in the form of machine-executable format.

3. The method of claim 1, wherein the logical functions are in the form of human-readable format.

4. The method of claim 3, wherein the human-readable format comprises decision trees or Bayesian networks.

5. The method of claim 1, wherein the organizing the neurons comprises:
arranging the neurons within each group in a vector or a matrix structure such that the neurons are iterated over.

6. The method of claim 1, comprising:
determining connectivity patterns of each neuron by normalizing its incoming weight.

7. The method of claim 1, comprising:
determining the logical functions based on weights each neuron applies to its inputs and the respective neuron's bias factor.

8. The method of claim 1, wherein the neural network is an essence neural network (ENN).

9. The method of claim 1, wherein the processing of the sub concepts to obtain neurons comprises:
processing the sub concepts to obtain differentia neurons associated with the sub concepts, wherein the differentia neurons provide a relative distinction between the sub concepts;
integrating the differentia neurons to obtain sub concepts neurons, wherein the sub concepts neurons provide an absolute distinction of sub concepts; and
integrating the sub concepts neurons to obtain concept neurons that form an output of the neural network.

10. The method of claim 1, wherein unsupervised learning is used to determine hierarchical structure of the sub concepts.

11. A system for deep distilling, the system comprising a processor and an associated memory, the processor being configured to:
obtain one or more training samples for training an artificial neural network;
determine multiple sub concepts within the training samples such that a minimum number of linearly separable sub concept regions are formed;
process the sub concepts to obtain neurons that form an output of the neural network:
organize the neurons into one or more groups with similar connectivity patterns; and
interpret the neurons as implementing one or more logical functions.

12. The system of claim 11, wherein the logical functions are in the form of machine-executable format.

13. The system of claim 11, wherein the logical functions are in the form of human-readable format.

14. The system of claim 13, wherein the human-readable format comprises decision trees or Bayesian networks.

15. The system of claim 11, wherein to organize the neurons, the processor is configured to arrange the neurons within each group in a vector or a matrix structure such that the neurons are iterated over.

16. The system of claim 11, wherein the processor is configured to determine connectivity patterns of each neuron by normalizing its incoming weight.

17. The system of claim 11, wherein the processor is configured to determine the logical functions based on weights each neuron applies to its inputs and the respective neuron's bias factor.

18. The system of claim 11, wherein the neural network is an ENN.

19. The system of claim 11, wherein for the processing of the sub concepts to obtain neurons, the processor is configured to:
process the sub concepts to obtain differentia neurons associated with the sub concepts, wherein the differentia neurons provide a relative distinction between the sub concepts;
integrate the differentia neurons to obtain sub concepts neurons, wherein the sub concepts neurons provide an absolute distinction of sub concepts; and
integrate the sub concepts neurons to obtain concept neurons that form an output of the neural network.

20. The system of claim 11, wherein the processor is configured to determine hierarchical structure of the sub concepts by unsupervised learning.
